(19) United States
(12) Patent Application Publication
(10) Pub. No.: US 2006/0267333 A1
(43) Pub. Date: Nov. 30, 2006

(54) Wide paper

(76) Inventor: James Michael Stavoe, Schaumburg, IL (US)

Correspondence Address: James Michael Stavoe, 151 Barton Circle, Schaumburg, IL, 60194, US

(21) Appl. No.: 11/442,931

(22) Filed: May 30, 2006

Related U.S. Application Data
(60) Provisional application No. 60/685,315, filed on May 31, 2005.

(51) Int. Cl. B42D 1/00

(52) U.S. Cl. 281/2

(57) ABSTRACT

The current invention as presented is sized, shaped and incorporates graphics for a horizontal orientation and use. Preferably made of white, or off-white, paper stock each sheet may be of a variety of colors or pastels, with, or without, a variety of optional embedded images. Additionally each sheet contains a plurality of parallel lines on the front and possibly on the back for writing and recording information. The paper is of a certain dimensions, or dimensional relationship, which provides for the width being greater than the height; and, provides for the horizontal recording and presentation of information. In addition to its dimensions, the look, feel, thickness, rigidity, opacity, durability, ink absorption, pigment adhesion, and other characteristics are sufficient to provide it the durability for use with a variety of applications requiring a landscape, horizontal, broad, or wide orientation. The inclusion of a plurality of parallel lines, or shading, provides a horizontal orientation and guide for the orderly recording notes, information, images, and other data along the horizontal, or wide, axis of the paper.

### CROSS REFERENCE TO RELATED APPLICATIONS

This application claims the benefit of provisional patent application Ser. No. 60/685,315, filed 2005 May 31 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

The invention is in the field of writing paraphernalia and relates particularly to an attractive, convenient and functional paper which is sized, constructed and ornamented to provide for optimal recording and presentation of information.

2. Prior Art

Paper has been used for thousands of years; however, since the advent of the Information Age writing equipment, supplies, notepads, paper stock, specialty papers, and related items have come in a wider variety of forms and in greater volumes than in any prior time in history. Specifically with regard to paper, the variety of styles, characteristics, weights, surfaces, and uses has never been greater than it is today.

Despite the number of products available in the market, specialized needs continue to drive improvements in design and performance requirements. Even with all the recent advancements in paper technologies, until the present invention there has not been a paper product with the superior usefulness, utility, appearance and other characteristics, as provided for in the current invention. The present invention is designed to record and present information in a more efficient and effectively manner than any other paper currently available.

Demonstrating a usefulness and filling a need is a must for a product to succeed and proliferate. One such example are the needs which were filled by 3M's Post-it® Sticky notes. Originally available in limited styles, this product is now available in a variety of sizes, shapes, colors, graphics, and custom images from a broad range of manufacturers. While originally there was no product category for sticky notes, the breath of offerings currently available clearly demonstrates that there is now a need that this product is filling.

Another example of the breadth of the paper market is the myriad of watermark, embedded image, weights, boarders, graphics, and other specialty papers available in the market today. A walk through any office supply or stationery shop will quickly demonstrate a glimpse into the breadth and depth of the offerings available. Many companies and organizations spend a great deal of time, energy and resources to maintain a particular image; and, often the paper products they utilize are an integral part of creating and maintaining that image. In other cases industry or professional standards have lead to the creation and utilization of specialty papers. One such industry example is accounting ledger paper; which, although it comes in a variety of formats, it maintains common elements in each of the various offerings, such as columns, rows, and specific color coding. Despite the wide range of papers available, until the present invention, there has not been a singular paper product that effectively addresses the public's need to record and present information and data in a horizontal format.

Although many of us learned to write in the 1^{st} and 2^{nd} grade using standard Zaner-Bloser™ Primers, which provide for a landscape oriented paper with broken line indices; generally after the 3^{rd} grade the vast majority of writing is on portrait, or vertically, oriented paper. U.S. Pat. No. 6,302,696 issued Oct., 2001 to O'Neill recognized a 12″ width, by 9″ height wide format in her adolescent teaching paper. U.S. Pat. No. 3,638,332 issued Feb., 1972 to Jones also presented, in image format, a horizontal sheet with the addition of colors “to appeal to the imagination and love of play” in children. However, the graphics, dimensions, size, durability, shape and weight, as well as other paper characteristics and properties of both the aforementioned designs do not lend themselves to a broad variety of uses. In fact, U.S. Pat. No. 4,173,082 issued Nov., 1979 to Niquette, recognizes the short comings between “the paper used for teaching writing skills” and “paper on which adults normally write upon.” Once an individual has passed the 2^{nd} grade there has not been a standard medium for writing and presenting information in a horizontal format. In fact until the present invention there has not been an acceptable, standardized, adult, horizontal format paper, available for everyday use.

While some paper products address specific needs or industries, until the present invention, there has not been a singular useful format available for the general public to record and present information and images in a horizontal format. As previously noted, the accounting industry often uses a multi-column ledger sheets to record and present information; however, the multi-columnar nature and frequently shaded areas, breaks the paper into zones and often directs the eye vertically, as a result, the vertical orientation of the information makes this style of paper unacceptable for general writing, note taking and information presentation.

Photographers often use, a horizontal, or landscape, orientation to present photographs in the most favorable fashion. In the case of photographs, the developers generally use a sheet of paper which is blank, gloss coated or has a textured surface. However, photographic paper generally does not have additional graphics or lines which would distract or interfere with the photograph. Again, this blank photographic paper does not possess the characteristics or graphic ornamentation needed to provide a useful tool for writing or recording non-photographic information.

Notes Cards, Index Cards and Postcards often utilize a format that provides a horizontal orientation. Again, there are many short comings with this medium outside their intended use. Generally, these media provide a very limited amount of space to record and present information; additionally, the dimensions do not lend themselves to modern office equipment. Further the paper weights are generally heavier than most stationery style paper and overall their characteristics do not meet the public's need to record larger amounts of information.

In addition to addressing the problem of providing a standard horizontal recording and presentation medium; in many cases the present invention, will actually increase the user's efficiency. As one example, the current invention more closely aligns with the dimension of most modern computer screens. As a result, scanned, ‘Full Screen’ images and written documents recorded on a sheet of the invention as presented will fit more completely on computer monitors. Not only will an image more fully utilize the space available on a standard computer screen, but the information recorded on the current invention will more effectively fill the image area of most standard video projection units, panel screen devices, television monitors, and projectors; and, information recorded on the current invention generally aligns more closely with the most common electronic recording and presentation systems. When images which were recorded on the current invention are displayed on any of these electronic medium, there is less under utilized margin space and images can be presented at a greater magnification without losing information off the top or bottom of the screen, as is the case using images recorded from ordinary paper. Also, when using the current invention to record information and creating presentation, the media more closely aligns with an electronic media they may ultimately be presented on. As a result the user has a greater awareness of the final layout and appearance sooner in the development process.

Although only a few benefits have been mentioned above, the list of uses and benefits to the user is extensive. The range of information recording and presentation options; as well as wide range of benefits, has not been available with any previous product or device, prior to the present invention.

### OBJECTS AND ADVANTAGES

Accordingly, besides the objects and advantages of the present invention describe above, several additional objects and advantages of the present invention are:

a) to provide a media that has greater recording space within the same overall dimensions as typical, traditional media;

b) to provide a media that has greater presentation space within the same dimensions as traditional media;

c) to provide a media that is more ergonomically oriented than current, ordinary, writing media;

d) to provide a media that keeps the work area physically closer to the user;

e) to provide a media that fits more conveniently in a variety of traditional working environments, such as cubicles and desk tops;

f) to provide a media that fits more conveniently in a variety of extemporaneous work areas, such as an airplane tray tables;

g) to provide a media which reduces wasted, right to left hand and eye motion;

h) to provide a media which fits into presentation binders in a more compelling fashion;

i) to provide a media that is compliant with modern office machinery and equipment;

j) to provide a media that is compliant with most current office filing and recording systems;

k) to provide a media that allows for the free flow of the eyes and hands along a greater linear path;

l) to provide a media that allows for the construction, recording and presentation of longer thoughts, longer information segments, and longer data strings without interruption;

m) to provide a media that allows for the construction, recording and presentation of more complex thoughts, more complex information segments, and more complex data strings without interruption;

n) to provide a writing media that is more stable than current, ordinary writing media;

### SUMMARY OF THE INVENTION

The present invention includes a combination of features which make it more useful, efficient, attractive and effective in providing a medium for recording and presenting information than is currently available.

The current invention as presented is designed and sized to record and present information efficiently and effectively in a horizontal orientation. Additionally, each page is engineered to fit into standard binders, files, and works in most modem office machinery and equipment without requiring updates, modifications, additional, or optional accessories.

The present invention is rectangular in shape with the horizontal axis being greater than the vertical axis. Additionally, each sheet contains a plurality of parallel lines oriented along the horizontal, or broad, axis of the page. An additional line, plurality of lines, graphic, or shading, running from the top to the bottom of the page, along the left side may be used to indicate a margin area.

The current invention is constructed typically of a “paper weight” paper generally in the range of 14 lb.-34 lb. range. The invention may be constructed of a heavier or lighter weight of paper depending on the specific application, intended use, purpose, or to meet specific requirements.

The front surface of the current invention has a plurality of parallel, horizontally oriented lines, or other patterns, which lend themselves to the orderly recording of information. Additionally, there may be a line, plurality of lines, or shaded area extending vertically near the left margin, for letters, numbers, times, dates, amounts, indicators, other indices, or for use a as an empty margin.

The front surface of the current invention is preferably white; but, may also be of a variety of colors including, but not limited to, off-white, canary, pink, light blue; or, a variety of pastels or other colors; or with embedded an image or watermark. The back surface of the current invention is similar to the front surface and is preferably white; but, may also be of a variety of colors, pastels, or contain embedded images or watermarks. On the individual page, the back surface of the sheet is preferably of a similar design to the front of the sheet; however, in alternate embodiments could be blank or have a variety of alternate graphics or images embedded.

The construction of the front surface of the sheet, and preferably the back surface, has a flat sheen, preferably providing a dull finish. Such surface is intended to provide a good writing texture and feel; and, provide easy visibility of data after it has been recorded on the page. The material also intends to dry the ink quickly, thereby preventing smudging, smearing and bleeding.

The present invention can be packaged in a variety of methods including, but not limited to individual sheets, loose leaf, reams, on a perforated roll, stacked accordion style, bound in a tablet, bound in a booklet, or in some other format.

It is therefore among the objects of the invention to provide a useful, efficient, effective, attractive and convenient to use sheet of paper, sized and constructed to promote the recording and presentation of information in a horizontal, landscape or “Wide” format. These and other objects, advantages and features of the invention will be apparent from the following description of a preferred embodiment, considered along with the accompanying drawings.

### DRAWINGS—REFERENCE NUMERALS

FIG. 1 is a frontal view of the current invention.

FIG. 2 is a view of the back of the current invention.

FIG. 3 is a side view of the current invention from the right, demonstrating its narrow nature.

FIG. 4 is a side view of the current invention from the left, demonstrating its narrow nature.

FIG. 5 is a top view of the current invention, demonstrating its thin nature.

FIG. 6 is a bottom view of the current invention, demonstrating its thin nature.

FIG. 7 is a front view of the current invention in an embodiment that omits the vertical margin reference line.

FIG. 8 is a view of the rear of the current invention in an embodiment that omits the vertical margin reference line.

FIG. 9 is a view of the current invention bound in a tablet at the left side.

FIG. 10 is a view of the current invention bound in the tablet form at the top.

FIG. 11 is a view of the current invention with optional standard three hole arrangement across the top.

FIG. 12 is a view of the current invention with an optional two hole arrangement along the left margin.

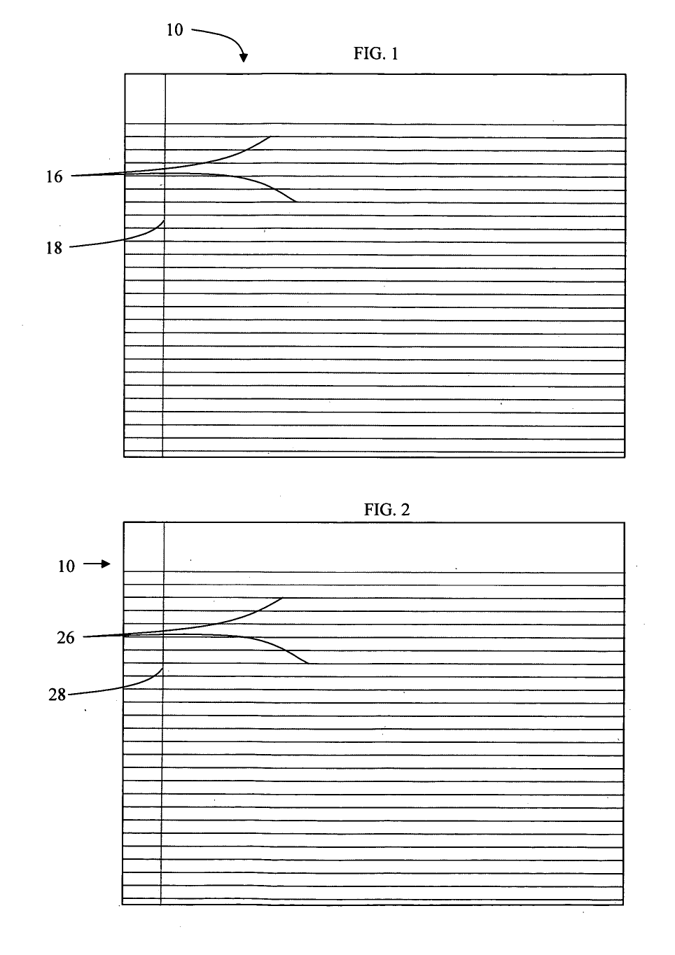

### DETAILED DESCRIPTION—FIG. 1 THROUGH FIG. 12—AND THE PREFERRED EMBODIMENTS

FIG. 1 of the drawings shows a frontal view of a sheet of the current invention 10 demonstrating its rectangular shape. On the surface of the current invention 10 are a plurality of horizontal lines 16 spaced appropriately for the taking of notes by the user. Said horizontal lines are parallel and preferably extended from one edge to the opposite edge of the surface. The front surface of the sheet 10 may also include a line 18 extending vertically down the height of the page, along the left margin, crossing the horizontal lines 16 as illustrated,

The sheet 10 is preferably white or off-white in color; however in alternate embodiments a variety colors, pastels, or embedded images may be used.

The dimensions of each sheet would preferably be approximately 11 inches in width, by approximately 8½ inches in height, by approximately 0.00335 inches in thickness. An alternate representation of the dimensions, could be made metrically, could be approximately 279.4 mm in width, by approximately 215.9 mm in height, by approximately 0.085 mm in thickness.

An alternate dimension could be approximately 14 inches in width, by approximately 8½ inches in height, by approximately 0.00335 inches in thickness. This format would most align with the dimensions of a sheet of legal paper; and, would provide a wider surface to record and present information.

An alternate dimension could be approximately 297 mm in width, by approximately 210 mm in height, by approximately 0.085 mm in thickness. This dimension most aligns with the international A4 metric size, and is presented as an example of the range of standard formats that the current invention could replace, supplement or align with.

Additional alternate dimensions, representing alternate embodiments, would also be available. Dimensions which permit use in standard office machines and equipment would be the preferred, although not limiting the dimensions of the current invention, with the dimensions of the width exceeding the dimensions of the height.

FIG. 2 shows a view the rear surface of a sheet of the current invention 10, and displays a similar graphic pattern to the front surface of the sheet including a plurality or horizontal lines 26 and a vertical margin line 28. In alternate embodiments the rear surface of the sheet could be of many different arrangements including, but not limited to blank, contain alternate graphics, or an imbedded image different from the front side of the sheet.

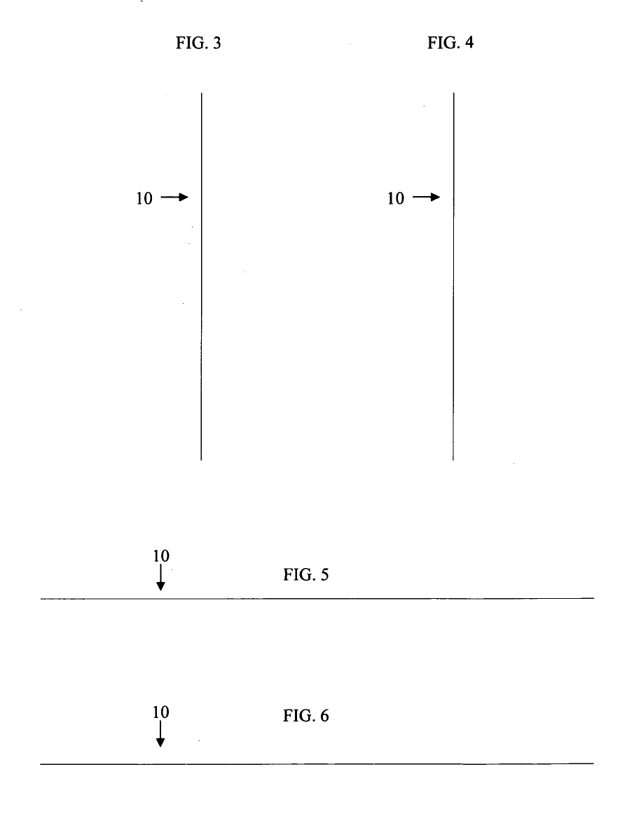

FIG. 3 illustrates the side view of a sheet of the current invention 10 from the right and is shown as an indication of its thin nature. The actual thickness of a sheet of the current invention 10 is approximately 0.00335″ or approximately 0.085 mm, but could be thinner or thicker depending on the specific application.

FIG. 4 illustrates the side view of a sheet of the current invention 10 from the left and is shown as an indication of its thin nature. The actual thickness of a sheet of the current invention 10 is approximately 0.00335″ or approximately 0.085 mm, but could be thinner or thicker depending on the specific application.

FIG. 5 illustrates the view of a sheet of the current invention 10 from the top; and, is an indication of its thin nature. The actual thickness of a sheet of the current invention is approximately 0.00335″ or approximately 0.085 mm, but could be thinner or thicker.

FIG. 6 illustrates the view of a sheet of the current invention 10 from the bottom; and, is an indication of its thin nature. The actual thickness of a sheet of the current invention is approximately 0.00335″ or approximately 0.085 mm, but could be thinner or thicker.

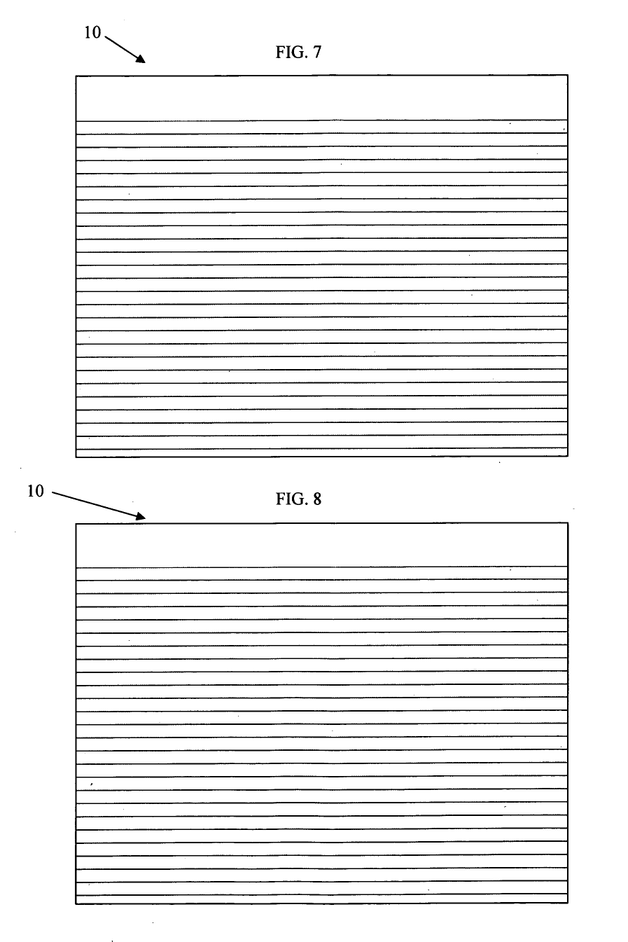

FIG. 7 illustrates a frontal view of a sheet of the current invention 10; however, in this embodiment the optional vertical margin line element has been omitted.

FIG. 8 illustrates a view of the back surface of a sheet of the current invention 10; however, in this embodiment the optional vertical margin line element has been omitted.

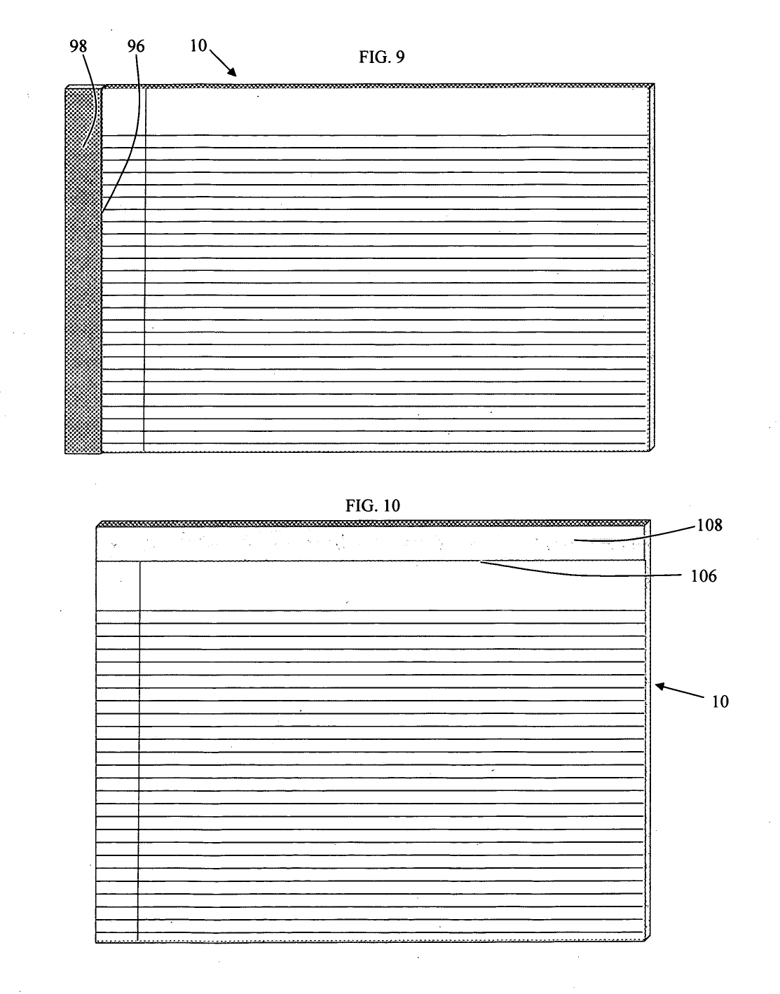

FIG. 9 illustrates the current invention 10 bound and packaged in a convenient tablet format. Said tablet may be bound on the side with micro-perforations or scoring 96 to allow sheets to be folded back or torn off on an individual basis. In the tablet format, the dimension of the width of a sheet of the current invention may be increased by approximately ¾″ 98 to allow for a margin area on the side to be used to bind several sheets into a tablet. The additional paper provides a detachable section on the side of the sheet to be utilized in creating the tablet format. Micro-perforations or scoring 96 in the paper, along the edge at the appropriate location, allow the sheet to be removed from the tablet easily.

FIG. 10 illustrates the current invention 10 bound and packaged in a convenient tablet format. Said tablet may be bound on the top with micro-perforations or scoring 106 to allow sheets to be folded back or torn off on an individual basis. In the “tablet” format, the dimension of the height of a sheet of the current invention may be increased by approximately ¾″ 108 to allow for a margin area on the side to be used to bind several sheets into a tablet. The additional paper provides a detachable section on the side of the sheet to be utilized in creating the tablet format. Micro-perforations or scoring 106 in the paper, along the edge at the appropriate location, allow the sheet to be removed from the tablet easily.

In the tablet format, the dimension of the height of a sheet of the current invention may be increased by approximately ¾″ 108 to allow for a margin area along the top to be used to bind several sheets into a tablet. The additional paper provides a removable section on the top of the sheet to be utilized in creating the tablet format. Micro-perforations or scoring 106 in the paper, along the edge at the appropriate location, allow the sheet to be removed from the tablet easily.

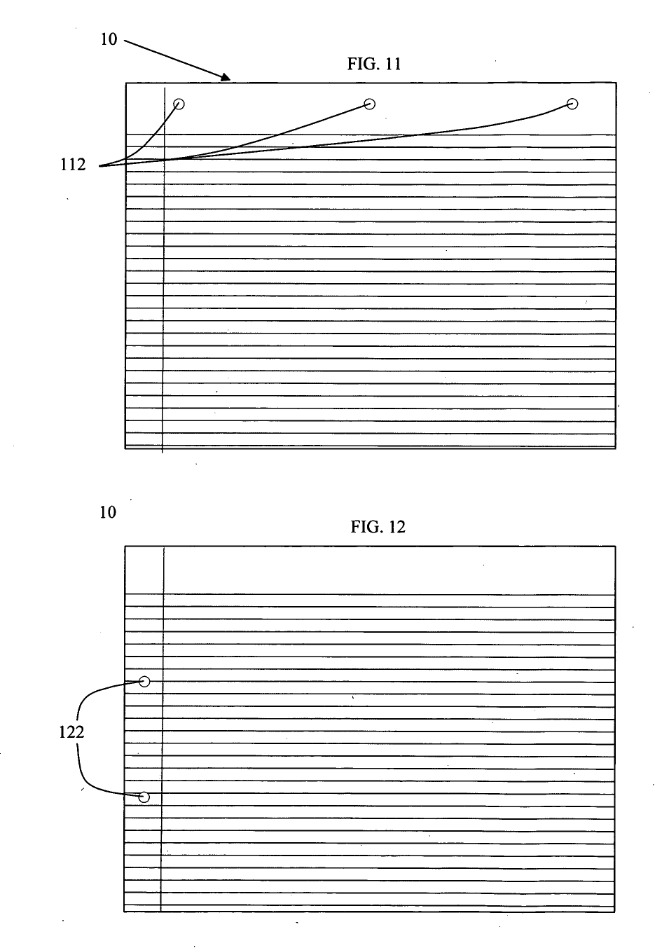

FIG. 11 shows a view of the current invention 10 containing an additional element such as, but not limited to, holes 112. FIG. 11 demonstrates one such accessory arranged in a standard three hole arrangement along the top of the horizontal axis of the page.

FIG. 12 shows a view of the current invention 10 containing an additional element such as, but not limited to, holes 122. FIG. 12 demonstrates one such accessory arranged in a standard two hole arrangement along the left margin in a vertical arrangement.

The surface characteristics and durability of the current invention 10 are important features for promoting ease of writing on the surface and good ink absorption or pigment adhesion. The preferred finish is a matte finish with good grain, such that bleeding of the ink from a felt tip, fountain, rolling ball type pen, or other writing instrument will not occur. The sheet stock used preferably is normal paper weight and preferably is of about 14 lb. to 34 lb. weight range, but may be heavier or lighter depending on the application.

A variety of finishes and sheet stock may be used for the current invention, preferably having an approximately equivalent feel to those described above. The sheet stock used should be such as to approximate a sheet paper in the general sense of the word. The surface should be one which dries ink quickly, without bleeding and which provides for pigment adhesion or absorption; and, the surface approximates flat or dull sheen.

In addition, as mentioned above, the current invention 10 can be produced in a variety of colors. Preferably light colors, and pastels, such as yellow, pale blue, pale green, pale pink, pale beige, ivory, as well as the white or off-white. The surface colors are not limited to those listed; however, those listed are examples which provide good contrast for promoting the visibility of images created by normal writing instruments such as pens, pencils, markers and others.

The above described preferred embodiment is intended to illustrate the principles of the invention, but not to limit its scope. Various other embodiments and modifications to this preferred embodiment will be apparent to those skilled in the art and may be made without departing from the scope of the invention.

What I claim is:

1. A device means for use in recording and presenting information in an efficient and effective format comprising:
a) a writing surface means in recording and displaying information,
b) said writing surface is substantially planar,
c) said writing surface contains a plurality of parallel lines,
d) said parallel lines are arranged in a manner consistent with the orderly recording and presentation of information,
e) said parallel lines are arranged to extend in alignment with the horizontal axis of the surface,
f) the width of said writing surface exceeds the height of said writing surface.

2. The writing surface of claim 1 is comprised of paper.

3. The writing surface of claim 1 is oriented so that the dimension width exceeds the dimension height.

4. The writing surface of claim 1 is oriented to record and present information in a horizontal format.

5. The writing surface of claim 1 is oriented to record and present in formation in a landscape format.

6. A sheet of paper which has a horizontal, or wide, orientation,
a) a sheet of paper having a rectangular shape, straight edges and having the dimensions and orientation which enable it to record and present information primarily in a or horizontal format,
b) a sheet of paper where the dimensions are greater in width than in height,
c) a sheet of paper where the front surface has a plurality of horizontal parallel lines,
d) a sheet of paper wherein said parallel lines are arranged in a pattern which lends itself to the orderly recording and presenting of information,
e) a sheet of paper with a back surface which contains a plurality of horizontal parallel lines arranged in a pattern which lends itself to the orderly recording and/or presenting of information; or, which may be blank, contain a graphic or another imbedded image.

7. The sheet of paper of claim 6, wherein the sheet is primarily of white, off white, or may be of stock of some other color or pastel.

8. The sheet of paper of claim 6, has a plurality of parallel lines spanning the width of the paper, which lends it to the orderly recording and presenting of information,
a) said parallel lines are of equal distant and generally conform to standard wide ruled, narrow ruled or college ruled separation,
b) said parallel lines are equal distant and generally conform to standard approximate ⅜ inch separation or approximate 5/16 inch separation.

9. The sheet of paper of claim 6, wherein the front surface has a blank margin area at the top, above the parallel lines.

10. The sheet of paper of claim 6, wherein the front surface has a graphic line, plurality of lines, shaded area or some other graphic extending downward indicating a margin area on the left side of the sheet,
a) a vertical line, or graphic, set approximately 1″ from the left edge of the sheet of paper.

11. The sheet claim 6, provides for presentation to be in a horizontal orientation with parallel lines being separated by an equal distance,
a) the horizontal guide lines generally conform, but are not limited to, the standard wide ruled, approximate ⅜ inch, narrow ruled and college ruled approximate 5/16 inch separation; however, the distance between the lines may vary for the other applications,
b) the horizontal lines are parallel to the upper and lower edge of said paper.

12. The sheet of claim 6, may further be bound or packaged in a variety of methods including, but not limited to, individual sheets, stacked in a ream fashion, bound on the side or top as a tablet, spiral bound as in a booklet, in accordion tear-sheet fashion, on a roll with perforations or markings indicating the boundaries, or in a variety of other fashions.

13. The sheet of claim 1, wherein the sheet is substantially of weight stock in the 14 lb. to 34 lb. range; but may be of significantly lighter or heavier weight in alternate embodiments.

14. The sheet of paper of claim 13, wherein the paper is of stock in the range of about 14 lb. to 34 lb., with a surface finish generally of a dull sheen.

15. The sheet of paper of claim 13, wherein the sheet has surface finish and durability to provide for drying ink quickly and good pigment adhesion, so as not to allow smudging, smearing, bleeding, or other adverse affects as information is recorded to the surface of the sheet.

16. The sheet paper of claim 13 may contain additional elements such as holes in predetermined locations which would allow it the sheet to be incorporated into a binder or other office equipment,
a) the holes may be arranged in a variety of patterns including, but not limited to, two hole, three hole, five hole, six hole, seven hole patterns for use in standard binders or may be arranged in some other pattern.

17. A device means for use in recording and presenting information in an efficient and effective format comprising:
a) said device is constructed of paper,
b) said paper has a front and rear writing surface,
c) said front surface is essentially planar,
d) said front surface is essentially flat,
e) said front surface has an essentially smooth finish,
f) said front surface provides for the adhesion or absorption of pigment,
g) said front surface has graphics to promote the orderly recording of information,
h) said graphics contain a plurality of parallel lines,
i) said parallel lines are oriented horizontally across the front surface,
j) said surface is oriented with the horizontal dimension being greater than the vertical dimension,
k) said device has a rear surface,
l) said rear surface is essentially planar,
m) said rear surface is essentially flat,
n) said rear surface has an essentially smooth finish,
o) said rear surface provides for the adhesion or absorption of pigment,
p) said rear surface has graphics to promote the orderly recording of information,
q) said graphics contain a plurality of parallel lines,
r) said parallel lines are oriented horizontally across the surface,
s) said surface is oriented with the horizontal dimension being greater than the vertical dimension.
